(19) United States
(12) Patent Application Publication
(10) Pub. No.: US 2014/0331507 A1
(43) Pub. Date: Nov. 13, 2014

(54) NOVEL JIG SAW

(71) Applicant: Yue Huang, Ningbo (CN)

(72) Inventor: Yue Huang, Ningbo (CN)

(73) Assignee: NINGBO BLACKPINE TOOLS CO., LTD, Ningbo (CN)

(21) Appl. No.: 14/343,636

(22) PCT Filed: Nov. 9, 2011
(86) PCT No.: PCT/CN2011/001878

§ 371 Date: Jun. 23, 2014

(30) Foreign Application Priority Data
Sep. 9, 2011 (CN) 201110276011.9

(51) Int. Cl. B23D 49/16

(52) U.S. Cl. CPC B23D 49/165
USPC 30/394

(57) ABSTRACT

A jig saw comprises a head (1), a motor, a first drive gear linked with a motor output end (3), and a first reciprocating lever (71) fixed with a first saw blade (101). The first drive gear is hinged with an end of a first connecting rod (61) in an upward eccentric manner, and the other end of the first connecting rod (61) is hinged with the first reciprocating lever (71). The jig saw further comprises a second drive gear linked with the motor output end (3). The second drive gear is hinged with an end of a second connecting rod (62) in an eccentric manner, and the other end of the second connecting rod (62) is hinged with a second reciprocating lever (72) that is fixed with a second saw blade (102). A linear limit mechanism that enables the first reciprocating lever (71) and the second reciprocating lever (72) to maintain a distance therebetween and be capable of linear motion is further disposed. The first saw blade (101) and the second saw blade (102) are respectively clamped on inner side surfaces close to each other at lower portions of the first reciprocating lever (71) and the second reciprocating lever (72). Directions of linear reciprocating motions of the first saw blade and the second saw blade are opposite. In the present invention, components are designed to be symmetrical, so that the jig saw runs stably, is easy to operate, and has high working efficiency.

### FIELD OF INVENTION

The present invention relates to a kind of novel jig saw, and more specifically relates to a novel jig saw having double saw blades.

### BACKGROUND OF INVENTION

Electrical jig saw is a kind of common tool widely used in different industries such as those relating to cars, motion transmission mechanisms, wood molding, decorating and leather processing. By means of vertical reciprocal movement, a saw blade can cut curves or straight lines on work pieces made of wood, metal, plastic or rubber etc. By adjusting the positioning angles of a base plate at its left and right sides, the saw blade can cut along an inclined surface.

An electrical jig saw commonly available nowadays usually comprises a motor driving an eccentric gear which in turn drives a reciprocating arm to achieve reciprocal cutting movement. A kind of motion transmission mechanism of a jig saw is disclosed in Chinese patent publication number CN201644927U, according to which an eccentric gear and a large gear are concentrically mounted on a gear shaft; a rotor is mounted on a motor shaft and is engaged with the large gear for torque output so as to drive and rotate the gear shaft; eccentric shaft components are mounted by interference fit on the eccentric gear; the eccentric shaft components passes through a rounded rectangular hole of a reciprocating arm; a saw blade is mounted on the reciprocating arm through a blade mounting seat; when the eccentric gear rotates, its rotational movement is transformed to linear reciprocal movement along a vertical plane.

According to the electrical jig saw as mentioned above, vibration of the entire electrical jig saw along Y and X axes will necessarily occur when the reciprocating arm moves reciprocally. In order to eliminate the vibration, a balance block can be provided along the Y axis. However, it is very difficult for an existing jig saw to be appropriately fitted with such a balance block; furthermore, since an existing jig saw is usually equipped with speed adjusting means for adjusting working speed in accordance with different working requirements, an appropriate amount of balancing force is even more difficult to be determined with these different working speeds; besides, it is more difficult to provide the balance block on the X axis than on the Y axis. Also, since the teeth of the blade is oriented to one single side, the blade can only perform cutting when it moves upwardly; when the blade moves upwardly, the entire jig saw machine is sunk downwardly, and this downward sinking force is solely borne by a base; due to reciprocal movement of the blade, the base will also experience vertical reciprocal movement and thus causing difficulties in maintaining balance during operation, thereby affecting the use of the electrical jig saw.

### SUMMARY

In view of the disadvantages now existing in the prior art, the present invention provides a novel jig saw which has better working efficiency and enables steady cutting operation and smooth control.

The present invention adopts the following technical proposal: A novel jig saw comprising a head, a motor disposed inside the head, a first transmission gear linked with a motor output end of the motor, a first connecting rod, and a first reciprocating lever fixed with a first saw blade; the first transmission gear is eccentrically hinged with one end of the first connecting rod, while another end of the first connecting rod is hinged with the first reciprocating lever; the novel jig saw is characterized in that:

the novel jig saw also comprises a second transmission gear linked with the motor output end, a second connecting rod, and a second reciprocating lever fixed with a second saw blade; the second transmission gear is eccentrically hinged with one end of the second connecting rod, while another end of the second connecting rod is hinged with the second reciprocating lever.

A linear movement limiting mechanism is also provided to maintain linear movement of and a spacing between the first reciprocating lever and the second reciprocating lever; the first saw blade is clamped at an inner side of a lower portion of the first reciprocating lever whereas the inner side of the lower portion of the first reciprocating lever is a side proximate to the second reciprocating lever; the second saw blade is clamped at an inner side of a lower portion of the second reciprocating lever whereas the inner side of the lower portion of the second reciprocating lever is a side proximate to the first reciprocating lever; linear reciprocal movement of the first saw blade and linear reciprocal movement of the second saw blade have mutually opposite moving directions.

Preferably, the first transmission gear is a first large gear directly engaged with the motor output end; the second transmission gear is a second large gear directly engaged with the motor output end; the first large gear and the second large gear are coaxially positioned; an eccentric hinging point between the first connecting rod and the first large gear and an eccentric hinging point between the second connecting rod and the second large gear are symmetrically arranged with respect to an axial line according to which the first large gear and the second large gear are coaxially positioned. The above configurations have simple structures and enable convenient installation; of course, if spatial requirements allow, other substitutes such as sprockets may be used for transmission instead of using the transmission gears.

A first eccentric hole is provided on the first large gear; a second eccentric hole is provided on the second large gear; a first pin that matches the first eccentric hole is provided inside the first eccentric hole; a second pin that matches the second eccentric hole is provided inside the second eccentric hole; an end of the first connecting rod is hinged with the first pin; an end of the second connecting rod is hinged with the second pin; accordingly, the connecting rods and the large gears are eccentrically hinged.

The linear movement limiting mechanism comprises upper sliding rails to prevent the first reciprocating lever and the second reciprocating lever from moving frontward and backward, and also comprises lower sliding rails to prevent the first reciprocating lever and the second reciprocating lever from moving leftward and rightward. By limiting the reciprocating levers so that they cannot move frontward, backward, leftward and rightward, linear reciprocal movement of the reciprocating levers can be ensured, further, the reciprocating levers are spaced apart with respect to each other with a certain distance, thereby facilitating the movement of the saw blades.

The upper sliding rails for preventing frontward and backward movement of the reciprocating levers are two in number and the two upper sliding rails are oppositely positioned; each of the two upper sliding rails are provided with a U-shaped slot extending longitudinally therein; an upper portion of the first reciprocating lever and an upper portion of the second reciprocating lever are each disposed inside a corresponding U-shaped slot.

The lower sliding rails for preventing leftward and rightward movement of the reciprocating levers are two in number; the two lower sliding rails are oppositely positioned and each of the two lower sliding rails is provided with three raised ribs extending inwardly; the two lower sliding rails form two laterally extending slots; the upper portion of the first reciprocating lever is disposed inside one of the two laterally extending slots, and the upper portion of the second reciprocating lever is disposed inside another one of the laterally extending slots.

According to an aspect of the present invention, a front surface and a back surface of a lower portion of at least one of the first reciprocating lever and the second reciprocating lever are removably fixed and tightened with blade presses, one on each surface; a slot is formed between the two blade presses at the inner side of the lower portion of a corresponding reciprocating lever for insertion of a corresponding saw blade.

According to another aspect of the present invention, a front surface or a back surface of a lower portion of at least one of the first reciprocating lever and the second reciprocating lever is removably fixed and tightened with a blade press; a slot is formed between the blade press and a slot opening on the inner side of the lower portion of a corresponding reciprocating lever for insertion of a corresponding saw blade.

Each of the two saw blades does not have clamping surfaces being two straight surfaces oriented perpendicular to a plane of the clamping force of the blade presses; instead, each of the two saw blades has clamping surfaces being oriented along the same plane of the clamping force of the blade presses and both clamping surfaces are inclined surfaces; accordingly, the difficulties in mounting the saw blades in an existing double-blade jig saw are resolved; also, widths of the slots in which the saw blades are clamped are adjustable, thereby ensuring fixation of the saw blades while preventing the saw blades from being locked.

Both the slots mentioned above have conical cross sections whereas shorter sides of the conical cross sections are positioned away from the respective inner sides of the respective reciprocating levers in order to further prevent the saw blades from being loosen.

The jig saw may also comprise guiding wheel rack components for limiting movement of the first saw blade and the second saw blade; the guiding wheel rack components comprise a guiding wheel rack link rod fixedly provided; a lower end of the guiding wheel rack link rod is rollably mounted with two guiding wheels arranged adjacent to each other via a guiding wheel pin; a portion of the guiding wheel pin between the two guiding wheels is provided with a guiding wheel gasket; a guiding slot being passed through by the first saw blade is formed between the guiding wheel gasket and one of the guiding wheels, and another guiding slot being passed through by the second saw blade is formed between the guiding wheel gasket and another one of the guiding wheels. Accordingly, movement of the two saw blades is further supported and guided, thereby ensuring steady linear movement of the two saw blades and ensuring that the two saw blades used for cutting are spaced apart with a suitable distance which keeps the two saw blades close to each other but not interfering with each other so that both of the two saw blades can freely move up and down.

Compared with the existing prior art, the present invention has the following advantages: The motor of the present invention can drive the two transmission gears simultaneously, thereby driving the two connecting rods which in turn drive the two reciprocating rods to move up and down in mutually opposite directions during each movement. Since a saw blade moves upwardly while another saw blade moves downwardly, the electrical jig saw machine bear an upward force and a downward force at the same time, and these two forces are offset such that the machine bear nearly no external forces, thereby avoiding the problem of imbalance. Vibration of the machine due to cutting operation is significantly reduced, and the machine can perform cutting smoothly even without a base plate with steady, highly efficient and safe cutting operation. Moreover, both the slots used for insertion of the two saw blades have conical cross sections, and each of the two saw blades does not have clamping surfaces being two straight surfaces oriented perpendicular to a plane of the clamping force of the blade presses; instead, each of the two saw blades has clamping surfaces being oriented along the same plane of the clamping force of the blade presses and both clamping surfaces are inclined surfaces; accordingly, the difficulties in mounting the saw blades in an existing double-blade jig saw are resolved, and the two saw blades of the jig saw can operate smoothly.

### DESCRIPTION OF FIGURES

FIG. 1 is a sectional view according to an embodiment of the present invention;

FIG. 2 is a schematic structural view of the two reciprocating levers and the saw blades thereon according to an embodiment of the present invention;

FIG. 3 is a schematic structural view of the two reciprocating levers according to an embodiment of the present invention;

FIG. 4 is a schematic structural view of the motion transmission mechanism according to an embodiment of the present invention;

FIG. 5 is an exploded structural view of the reciprocating levers and the sliding rails according to an embodiment of the present invention;

FIG. 6 is a sectional view along A-A of the guiding wheel rack components shown in FIG. 1.

### EMBODIMENTS

The present invention will be further described in detail below with reference to the accompanying drawings and an embodiment.

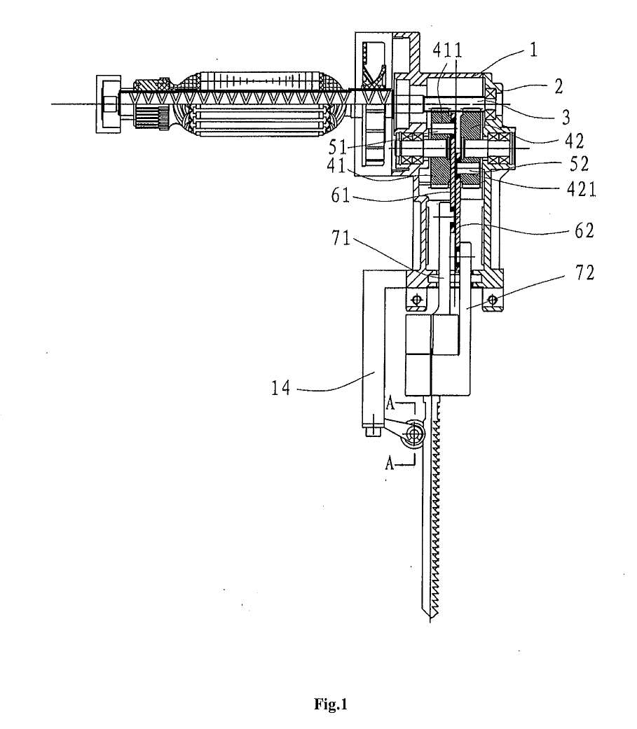

With reference to FIG. 1, a novel jig saw comprises a head 1 in form of a cabinet structure, a head cover 2 on the head 1 in form of a covering panel of the cabinet structure, and a motor being a power source disposed inside the head 1.

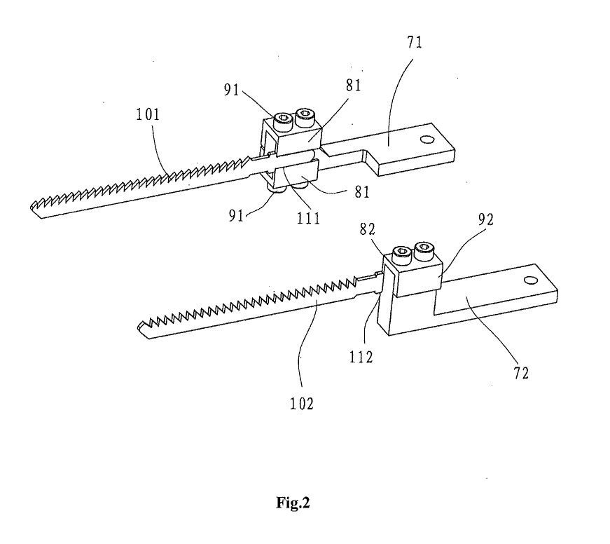

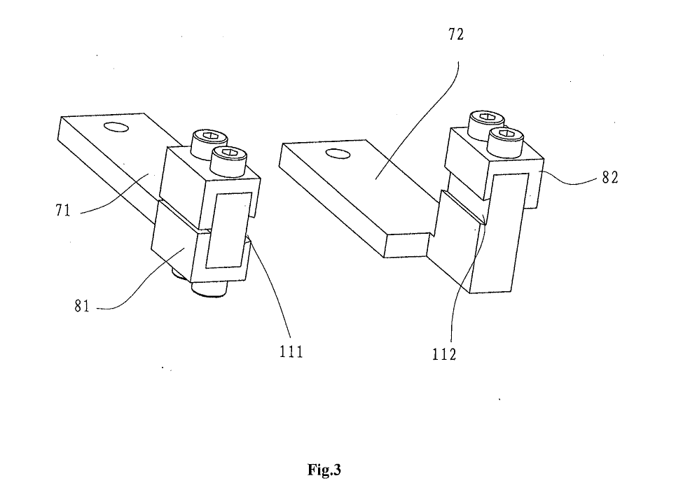

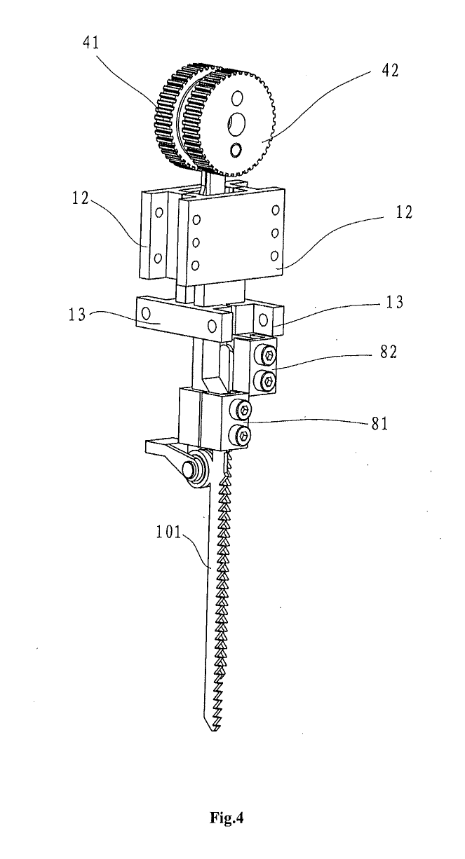

Power output from the motor is transmitted via motion transmission mechanism to blades used for cutting so that the blades can move reciprocally. Transmission gears, namely a first transmission gear and a second transmission gear, are linked with a motor output end 3 of the motor. In the present embodiment, the first transmission gear and the second transmission gear are a first large gear 41 and a second large gear 42 respectively and both the first and the second large gears are directly engaged with the motor output end 3. The first and the second large gears are provided with a first eccentric hole 411 and a second eccentric hole 421 respectively. The first eccentric hole 411 and the second eccentric hole 421 are disposed with a first pin 51 and a second pin 52 that match respectively with the first eccentric hole 411 and the second eccentric hole 421. An end of a first connecting rod 61 is hinged with the first pin 51, and another end of the first connecting rod 61 is hinged with an upper end of a first reciprocating lever 71. An end of a second connecting rod 62 is hinged with the second pin 52, and another end of the second connecting rod 62 is hinged with an upper end of a second reciprocating lever 72. In the present embodiment, the first reciprocating lever and the second reciprocating lever are both in L shape. As shown in FIG. 2 and FIG. 4, front and back surfaces of a lateral section of the first reciprocating lever 71 are provided with first blade presses 81, one on each surface; a front surface of a lower portion of the second reciprocating lever 72 is provided with a second blade press 82. A first saw blade 101 is inserted in a first slot 111 formed between the two first blade presses 81 at an inner side (i.e. the side proximate to the second reciprocating lever 72) of a lower portion of the first reciprocating lever 71. The two first blade presses 81 are clamped and tightened by using first bolts 91 in order to fix the first saw blade 101. A second saw blade 102 is inserted in a second slot 112 formed between the second blade press 82 and an inner side (i.e. the side proximate to the first reciprocating lever 71) of the second reciprocating lever 72. The second blade press 82 and the second reciprocating lever 72 are clamped and tightened by using a second bolt 92 in order to fix the second saw blade 102. By using the above method to fix the saw blades, widths of the first and the second slots can be adjusted so as to ensure that the saw blades can be fixed within their respective slots while preventing the saw blades from being locked inside. Preferably as in FIG. 3, both the first slot 111 and the second slot 112 have conical cross sections whereas shorter sides of the conical cross sections are positioned away from the respective inner sides of the respective reciprocating levers in order to further secure fixation of the saw blades so that they will not be loosen during working operation. Each of the two saw blades does not have clamping surfaces being two straight surfaces oriented perpendicular to a plane of the clamping force of the blade presses; instead, each of the two saw blades has clamping surfaces being oriented along the same plane of the clamping force of the blade presses and both clamping surfaces are inclined surfaces; accordingly, the difficulties in mounting the saw blades in an existing double-blade jig saw are resolved. Alternatively, the first reciprocating lever 71 and the second reciprocating lever 72 can adopt the same shape and clamp the saw blades in the same manner.

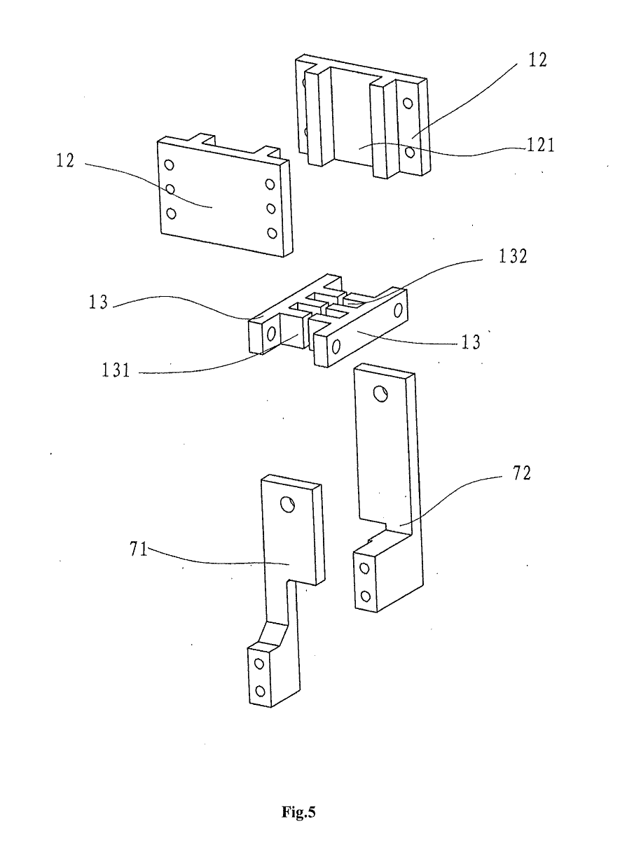

In order to maintain linear movement of the two reciprocating levers 71, 72, the two reciprocating levers 71, 72 are provided with a linear movement limiting mechanism. With reference to FIG. 4 and FIG. 5, two upper sliding rails 12 and two lower sliding rails 13 are provided. The two upper sliding rails 12 are oppositely positioned and they are provided with U-shaped slots 121 each extending longitudinally inside each of the two upper sliding rails 12. Upper portion of the first reciprocating lever 71 and upper portion of the second reciprocating lever 72 are each disposed inside a corresponding U-shaped slot of the U-shaped slots 121 of a corresponding upper sliding rail of the upper sliding rails 12. Accordingly, the two reciprocating levers 71, 72 are prevented from moving frontward and backward (i.e. leftward and rightward in the orientation of FIG. 1). The two lower sliding rails 13 are oppositely positioned and each of the two lower sliding rails 13 is provided with three raised ribs 131 extending inwardly (i.e. the three raised ribs of one of the lower sliding rails 13 extend and face towards the three raised ribs of another one of the lower sliding rails 13). Accordingly, the two lower sliding rails 13 form two laterally extending slots 132 for limiting the movement of the two reciprocating levers. The upper portion of the first reciprocating lever 71 and the upper portion of the second reciprocating lever 72 are also correspondingly disposed inside the laterally extending slots 132 to prevent the two reciprocating levers 71, 72 from moving leftward and rightward. Accordingly, linear reciprocal movement of the two reciprocating levers 71, 72 can be ensured, and the two reciprocating levers 71, 72 are spaced apart with respect to each other with a certain distance, thereby facilitating the movement of the saw blades.

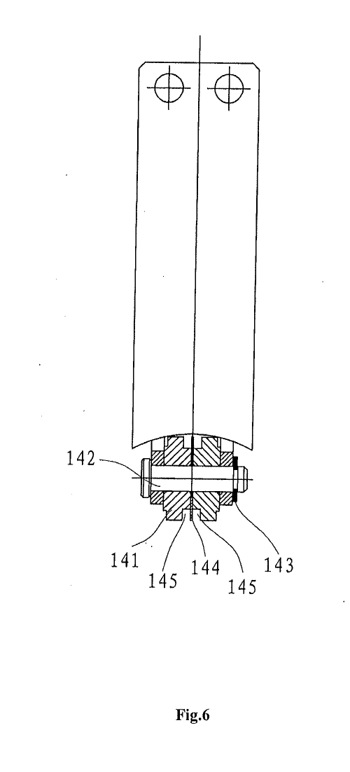

With reference to FIG. 1 and FIG. 6, the jig saw also comprises guiding wheel rack components. A guiding wheel rack link rod 14 is fixedly provided. A lower end of the guiding wheel rack link rod 14 is rollably mounted with two guiding wheels 141 arranged adjacent to each other via a guiding wheel pin 142. One end of the guiding wheel pin 142 is provided with an opening retainer ring 143 to prevent the two guiding wheels 141 from slipping outwardly. A portion of the guiding wheel pin 142 between the two guiding wheels 141 is provided with a guiding wheel gasket 144. Two guiding slots 145 each being passed through by a corresponding saw blade are formed between the guiding wheel gasket 144 and one of the guiding wheels 141 and between the guiding wheel gasket 144 and another one of the guiding wheels 141 respectively. Accordingly, linear movement of the two saw blades is maintained, while the two saw blades used for cutting are spaced apart with a suitable distance which keeps the two saw blades close to each other but not interfering with each other so that both of the two saw blades can freely move up and down.

When the motor is energized, the motor output end 3 rotates and therefore drives the two large gears engaged thereto to rotate; due to the connecting rods hinged eccentrically to the large gears respectively, an end of each of the connecting rods is driven to move in circular movement, while another end of each of the connecting rods drives a corresponding reciprocating lever of the two reciprocating levers to move; since the two upper sliding rails 12 and the two lower sliding rails 13 limit the moving direction of the two reciprocating levers, in other words, the two reciprocating levers are limited to longitudinal linear movement, linear movement of the two reciprocating levers drive the two saw blades to move linearly to perform cutting. It should be understood that, in the present embodiment, the two large gears are coaxially positioned; during a starting position, the eccentric hole of one of the two large gears and another eccentric hole of another one of the two large gears are symmetrically positioned with respect to the axial line of the two large gears; as such, the two saw blades can move in opposite directions. However, the two large gears may not be coaxially positioned or the two eccentric holes may not be symmetrically positioned given that other alternative configurations can also move the two saw blades in different directions; for example, the motor output end 3 may jointly move with the large gears through other gears or other transmission mechanisms.

The motor drives the two large gears each having an eccentric hole, thereby driving the two connecting rods which in turn drive the two reciprocating rods to move up and down in mutually opposite directions during each movement. This configuration avoids the problem of imbalance. Moreover, since a saw blade moves upwardly while another saw blade moves downwardly, the electrical jig saw machine bear an upward force and a downward force at the same time, and these two forces are offset such that the machine bear nearly no external forces. Vibration of the machine due to cutting operation is significantly reduced, and the machine can perform cutting smoothly even without a base plate.

1-10. (canceled)

11. A novel jig saw comprising a head, a motor disposed inside the head, a first transmission gear linked with a motor output end of the motor, a first connecting rod, and a first reciprocating lever fixed with a first saw blade; the first transmission gear is eccentrically hinged with one end of the first connecting rod, while another end of the first connecting rod is hinged with the first reciprocating lever; the novel jig saw is characterized in that:
the novel jig saw also comprises a second transmission gear linked with the motor output end (3), a second connecting rod, and a second reciprocating lever fixed with a second saw blade; the second transmission gear is eccentrically hinged with one end of the second connecting rod, while another end of the second connecting rod is hinged with the second reciprocating lever;
a linear movement limiting mechanism is also provided to maintain linear movement of and a spacing between the first reciprocating lever and the second reciprocating lever; the first saw blade is clamped at an inner side of a lower portion of the first reciprocating lever whereas the inner side of the lower portion of the first reciprocating lever is a side proximate to the second reciprocating lever; the second saw blade is clamped at an inner side of a lower portion of the second reciprocating lever whereas the inner side of the lower portion of the second reciprocating lever is a side proximate to the first reciprocating lever; linear reciprocal movement of the first saw blade and linear reciprocal movement of the second saw blade have mutually opposite moving directions.

12. The jig saw as in claim 11, wherein the jig saw also comprises guiding wheel rack components for limiting movement of the first saw blade and the second saw blade; the guiding wheel rack components comprise a guiding wheel rack link rod fixedly provided; a lower end of the guiding wheel rack link rod is rollably mounted with two guiding wheels arranged adjacent to each other via a guiding wheel pin; a portion of the guiding wheel pin between the two guiding wheels is provided with a guiding wheel gasket; a guiding slot being passed through by the first saw blade is formed between the guiding wheel gasket and one of the guiding wheels, and another guiding slot being passed through by the second saw blade is formed between the guiding wheel gasket and another one of the guiding wheels.

13. The jig saw as in claim 11, wherein the first transmission gear is a first large gear directly engaged with the motor output end; the second transmission gear is a second large gear directly engaged with the motor output end; the first large gear and the second large gear are coaxially positioned; an eccentric hinging point between the first connecting rod and the first large gear and an eccentric hinging point between the second connecting rod and the second large gear are symmetrically arranged with respect to an axial line according to which the first large gear and the second large gear are coaxially positioned.

14. The jig saw as in claim 13, wherein the jig saw also comprises guiding wheel rack components for limiting movement of the first saw blade and the second saw blade; the guiding wheel rack components comprise a guiding wheel rack link rod fixedly provided; a lower end of the guiding wheel rack link rod is rollably mounted with two guiding wheels arranged adjacent to each other via a guiding wheel pin; a portion of the guiding wheel pin between the two guiding wheels is provided with a guiding wheel gasket; a guiding slot being passed through by the first saw blade is formed between the guiding wheel gasket and one of the guiding wheels, and another guiding slot being passed through by the second saw blade is formed between the guiding wheel gasket and another one of the guiding wheels.

15. The jig saw as in claim 13, wherein a first eccentric hole is provided on the first large gear; a second eccentric hole is provided on the second large gear; a first pin that matches the first eccentric hole is provided inside the first eccentric hole; a second pin that matches the second eccentric hole is provided inside the second eccentric hole; an end of the first connecting rod is hinged with the first pin; an end of the second connecting rod is hinged with the second pin.

16. The jig saw as in claim 15, wherein the jig saw also comprises guiding wheel rack components for limiting movement of the first saw blade and the second saw blade; the guiding wheel rack components comprise a guiding wheel rack link rod fixedly provided; a lower end of the guiding wheel rack link rod is rollably mounted with two guiding wheels arranged adjacent to each other via a guiding wheel pin; a portion of the guiding wheel pin between the two guiding wheels is provided with a guiding wheel gasket; a guiding slot being passed through by the first saw blade is formed between the guiding wheel gasket and one of the guiding wheels, and another guiding slot being passed through by the second saw blade is formed between the guiding wheel gasket and another one of the guiding wheels.

17. The jig saw as in claim 11, wherein the linear movement limiting mechanism comprises upper sliding rails to prevent the first reciprocating lever and the second reciprocating lever from moving frontward and backward, and also comprises lower sliding rails to prevent the first reciprocating lever and the second reciprocating lever from moving leftward and rightward.

18. The jig saw as in claim 17, wherein the jig saw also comprises guiding wheel rack components for limiting movement of the first saw blade and the second saw blade; the guiding wheel rack components comprise a guiding wheel rack link rod fixedly provided; a lower end of the guiding wheel rack link rod is rollably mounted with two guiding wheels arranged adjacent to each other via a guiding wheel pin; a portion of the guiding wheel pin between the two guiding wheels is provided with a guiding wheel gasket; a guiding slot being passed through by the first saw blade is formed between the guiding wheel gasket and one of the guiding wheels, and another guiding slot being passed through by the second saw blade is formed between the guiding wheel gasket and another one of the guiding wheels.

19. The jig saw as in claim 17, wherein the upper sliding rails are two in number and the two upper sliding rails are oppositely positioned; each of the two upper sliding rails is provided with a U-shaped slot extending longitudinally therein; an upper portion of the first reciprocating lever and an upper portion of the second reciprocating lever are each disposed inside a corresponding U-shaped slot.

20. The jig saw as in claim 19, wherein the jig saw also comprises guiding wheel rack components for limiting movement of the first saw blade and the second saw blade; the guiding wheel rack components comprise a guiding wheel rack link rod fixedly provided; a lower end of the guiding wheel rack link rod is rollably mounted with two guiding wheels arranged adjacent to each other via a guiding wheel pin; a portion of the guiding wheel pin between the two guiding wheels is provided with a guiding wheel gasket; a guiding slot being passed through by the first saw blade is formed between the guiding wheel gasket and one of the guiding wheels, and another guiding slot being passed through by the second saw blade is formed between the guiding wheel gasket and another one of the guiding wheels.

21. The jig saw as in claim 17, wherein the lower sliding rails are two in number; the two lower sliding rails are oppositely positioned and each of the two lower sliding rails is provided with three raised ribs extending inwardly; the two lower sliding rails form two laterally extending slots; an upper portion of the first reciprocating lever is disposed inside one of the two laterally extending slots, and an upper portion of the second reciprocating lever is disposed inside another one of the laterally extending slots.

22. The jig saw as in any one of claims 21, wherein the jig saw also comprises guiding wheel rack components for limiting movement of the first saw blade and the second saw blade; the guiding wheel rack components comprise a guiding wheel rack link rod fixedly provided; a lower end of the guiding wheel rack link rod is rollably mounted with two guiding wheels arranged adjacent to each other via a guiding wheel pin; a portion of the guiding wheel pin between the two guiding wheels is provided with a guiding wheel gasket; a guiding slot being passed through by the first saw blade is formed between the guiding wheel gasket and one of the guiding wheels, and another guiding slot being passed through by the second saw blade is formed between the guiding wheel gasket and another one of the guiding wheels.

23. The jig saw as in claim 11, wherein a front surface and a back surface of the lower portion of at least one of the first reciprocating lever and the second reciprocating lever are removably fixed and tightened with blade presses, one on each surface; a slot is formed between the two blade presses at the inner side of the lower portion of a corresponding reciprocating lever for insertion of a corresponding saw blade.

24. The jig saw as in claim 23, wherein the slot has a conical cross section whereas a shorter side of the conical cross section is positioned away from the corresponding inner side of the corresponding reciprocating lever.

25. The jig saw as in any one of claims 23, wherein the jig saw also comprises guiding wheel rack components for limiting movement of the first saw blade and the second saw blade; the guiding wheel rack components comprise a guiding wheel rack link rod fixedly provided; a lower end of the guiding wheel rack link rod is rollably mounted with two guiding wheels arranged adjacent to each other via a guiding wheel pin; a portion of the guiding wheel pin between the two guiding wheels is provided with a guiding wheel gasket; a guiding slot being passed through by the first saw blade is formed between the guiding wheel gasket and one of the guiding wheels, and another guiding slot being passed through by the second saw blade is formed between the guiding wheel gasket and another one of the guiding wheels.

26. The jig saw as in claim 11, wherein a front surface or a back surface of the lower portion of at least one of the first reciprocating lever and the second reciprocating lever is removably fixed and tightened with a blade press; a slot is formed between the blade press and a slot opening on the inner side of the lower portion of a corresponding reciprocating lever for insertion of a corresponding saw blade.

27. The jig saw as in claim 26, wherein the jig saw also comprises guiding wheel rack components for limiting movement of the first saw blade and the second saw blade; the guiding wheel rack components comprise a guiding wheel rack link rod fixedly provided; a lower end of the guiding wheel rack link rod is rollably mounted with two guiding wheels arranged adjacent to each other via a guiding wheel pin; a portion of the guiding wheel pin between the two guiding wheels is provided with a guiding wheel gasket; a guiding slot being passed through by the first saw blade is formed between the guiding wheel gasket and one of the guiding wheels, and another guiding slot being passed through by the second saw blade is formed between the guiding wheel gasket and another one of the guiding wheels.

28. The jig saw as in claim 26, wherein the slot has a conical cross section whereas a shorter side of the conical cross section is positioned away from the corresponding inner side of the corresponding reciprocating lever.

29. The jig saw as in any one of claims 28, wherein the jig saw also comprises guiding wheel rack components for limiting movement of the first saw blade and the second saw blade; the guiding wheel rack components comprise a guiding wheel rack link rod fixedly provided; a lower end of the guiding wheel rack link rod is rollably mounted with two guiding wheels arranged adjacent to each other via a guiding wheel pin; a portion of the guiding wheel pin between the two guiding wheels is provided with a guiding wheel gasket; a guiding slot being passed through by the first saw blade is formed between the guiding wheel gasket and one of the guiding wheels, and another guiding slot being passed through by the second saw blade is formed between the guiding wheel gasket and another one of the guiding wheels.
